(19) United States
(12) Patent Application Publication
(10) Pub. No.: US 2004/0011805 A1
(43) Pub. Date: Jan. 22, 2004

(54) Prize vending machine

(76) Inventor: Gordon James Crompton, Kent (GB)

Correspondence Address: William M Lee, Barnes & Thornburg, P O Box 2786, Chicago, IL, 60690-2786, US

(21) Appl. No.: 10/398,816

(22) PCT Filed: Oct. 5, 2001
(86) PCT No.: PCT/GB01/04470

(30) Foreign Application Priority Data
Oct. 9, 2000 (GB) 0024672.8

(51) Int. Cl. B65H 3/00; B23Q 7/04

(52) U.S. Cl. 221/210

(57) ABSTRACT

A prize vending machine has a crane 1 moveable over a prize field 6 which may be loaded with prizes. The crane 1 may be moved from its home position 11 over dispenser 2 to a second position 12 under user control. Once a first grab attempt has been made repeat grab control 4 is actuated to allow a further grab attempt at second location 12 without returning the crane 1 to the first location 11.

### FIELD OF THE INVENTION

The present invention relates to a prize vending machine, in particular to a prize vending machine with a crane.

### BACKGROUND ART

Crane prize vending machines have been in use for many years. These types of prize vending machines comprise a cabinet containing a variety of different prizes, such as small toys. A crane mechanism with a claw or grabber at one end, to grab the prizes, is situated within the cabinet and the crane mechanism is controllable by the user once the appropriate credits have been inserted into the amusement machine. The user attempts to grab and retrieve, to a prize dispenser situated within the cabinet at the start position, one of the prizes from the cabinet within a set amount of time which is dependant on the credits inserted into the machine by the player. Once an attempt has been made to grab a prize, whether successful or not, the grabber is automatically returned to the prize dispenser located at the start position so that another game may be started. If the game was successful and a prize was picked up by the grabber the user can retrieve a prize from the prize dispenser situated at the start position.

As this is a highly competitive field there is a continual need to develop games which will keep the user interested and result in more of these amusement machines being sold.

### STATEMENT OF THE INVENTION

According to one aspect of the present invention, there is provided a prize vending machine comprising: a housing; a crane mechanism with a grabber attached to one end thereof, the crane mechanism being controllable by a user to effect movement of the crane mechanism from a first position to a user-influenced second position where a first attempt to grab a prize from within the housing is made; and a repeat grab control operable by the user, wherein the repeat grab control is enabled after movement of the grabber from the first position to the second position and actuation of the repeat grab control when enabled causes the crane mechanism to repeat the first grab attempt whilst the crane mechanism remains in the second position.

The repeat grab function may be enabled when sufficient credits have been inserted into the machine to allow more than one game. In the context of this specification, the term “credits” should be understood as including discs/coins, tokens, credits input on a card or other payment schemes.

Thus the grabber moves, under control of the user, from a first position to a second position and once in the second position the grabber may make an attempt to grab a prize from the housing. Subsequently, the grabber may either return to the first position if a prize has been picked up or if the credits/money inserted have run out. If no prize has been picked up by the grabber and enough credits remain the user has the option to press the repeat grab button and make a further attempt to grab a prize. Alternatively the user may let the crane return to the first position and the game starts again.

The presence of the repeat grab function enables the speed of consecutive games to be increased, as the grabber does not return to the first position after each game, but remains in the second position. This enables a player to have two or more attempts on the same prize without returning the grabber to the first position.

A further aspect of the present invention includes the feature that when a prize is picked up by the crane the repeat function may be disabled, via means such as infrared sensor or a switch positioned within the grabber. The switch or sensor is activated one a prize has been successfully picked up and a signal is then sent to the repeat grab button to be switched off. This enables that the repeat button can be disabled so it does not get accidentally pressed and release the prize picked up by the grabber, which might otherwise cause annoyance to a user.

The invention also relates to a method of operation of a prize vending machine having a crane mechanism and grabber, the method comprising: effecting movement of the crane mechanism under user control from a first position to a user-influenced second position; carrying out a grab attempt at the second position; enabling actuation of a repeat grab control; and, if the repeat grab control is actuated, repeating the grab attempt at the second position, and otherwise returning the crane mechanism to the first position.

### BRIEF DESCRIPTION OF THE DRAWINGS

Examples of the present invention will now be described in detail with reference to the accompanying drawings in which:

FIG. 1 is an example of a know crane-type amusement machine;

FIG. 2 is an example of the crane-type amusement machine according to the present invention;

FIG. 3 is a flow chart of a control mechanism for the crane amusement machine according to the present invention.

### DETAILED DESCRIPTION

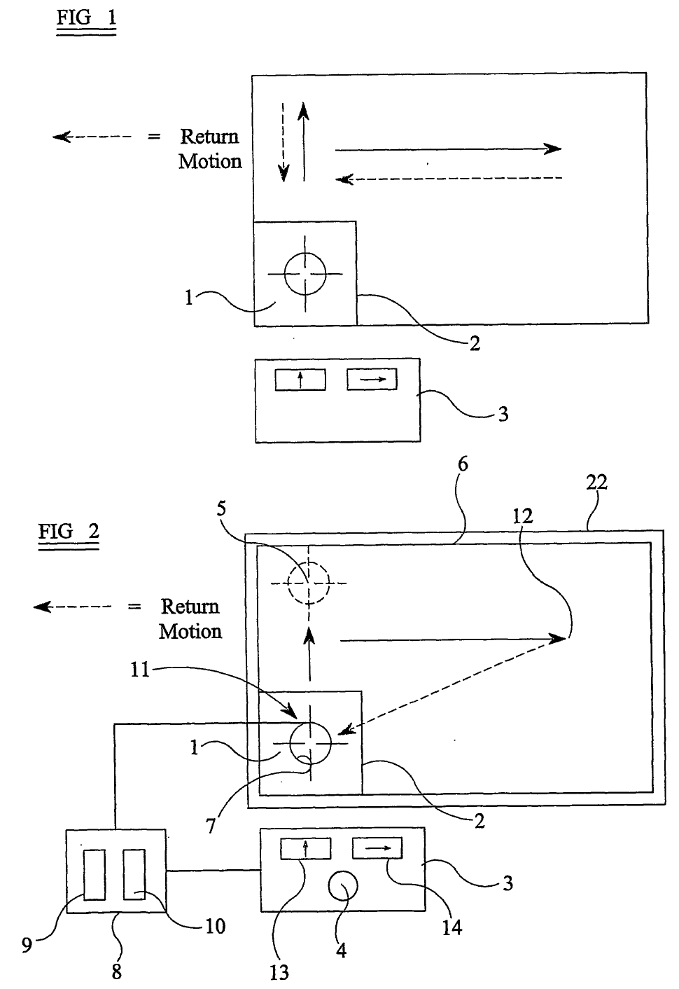

FIG. 1 shows a known crane grabber 1 at its home position over prize dispenser 2. Using the control panel 3 movement in the X and Y axis direction of the horizontal plane can be effected. Once the crane grabber has moved from its home position in order to try to grab a prize, the crane grabber will return to its home position at the prize dispenser 2 and the grabber will open in order to drop a prize down the prize dispenser 2. The crane grabber will always return to its home position once the game is over.

FIG. 2 shows an arrangement according to the present invention with crane grabber 1 at its resting or home position 11 over prize dispenser 2. Movement of the crane grabber is controlled by the control panel 3 and in particular Y control 13 and X control 14 which control motion of the crane grabber in the X-axis and Y-axis directions in the horizontal plane over prize field 6 which may support a number of prizes. There is a repeat grab button 4 located on the control panel 3. In use, once the grabber has moved under user influence using controls 13, 14 from the home position to the second position 12 the repeat grab button 4 is enabled and provided the user has inserted enough credits into the amusement machine the activation of this repeat grab button 4 will cause the grabber 1 to make another attempt at grabbing the prize whilst remaining in the second position. An alternative home position 5 is also shown.

Housing 22, which may be transparent, or opaque or partially transparent is provided around play field 6 and crane 1 to prevent users simply removing prizes from the play field 6 without playing the game.

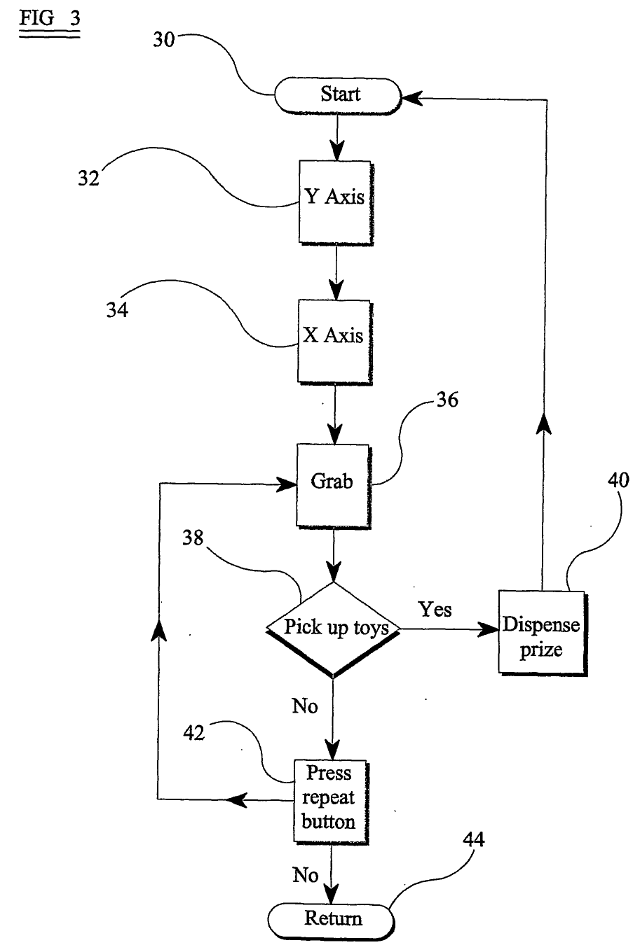

FIG. 3 is a flow chart of the control mechanism of the crane-type amusement machine. Once the game has started (step 30), by the insertion of the appropriate amount of credits into the machine the player can move the crane grabber mechanism in the X-axis (step 34) and Y-axis (step 32) directions. After this phase ends, generally after a predetermined time, the grabber 1 will lower automatically in a first attempt to grab a prize. If the attempt is successful tested in step 38, the grabber will return to its home position (step 40) and drop the prize into the prize dispenser. If the attempt is unsuccessful and enough credits remain, the user has the option (step 42) to press the repeat button in order to repeat the grab phase (step 36), though not the X and Y movement (steps 32, 34). Alternatively, the user may return the grabber to its home position, so that if the user does not want to press the return button after a failed attempt to pick up a prize, the grabber will return to the home/start position (step 44) where a new game may be started.

The control system is centred around a controller 8 including a microprocessor 9 and a memory 10. The controller 8 is connected both to control panel 3 and crane 1. The control system is run using software in memory 10 implementing the steps described above.

The microprocessor 9 receives a signal from the grabber via, for example an infrared sensor or a switch 7 in the grabber 1 which detects the presence of a prize in the grabber and if a prize is detected the repeat grab function will be disabled. If no prize is detected the repeat grab function will be enabled and the user can make a second attempt to grab a prize, without the grabber returning back to the start position.

The invention is not intended to be limited to the arrangements of the above embodiment, which is provided purely by way of example. Where only a single component is described it will be appreciated that in general a plurality of such components may be provided, and the use of the term “a”, singular nouns and singular verbs are not intended to exclude the plural.

In particular, the shape of the play field 6, location of the crane and the precise controls 13, 14 provided on control panel 3 may be varied as required. The form of components used, including without loss of generality the form of the housing 22 may varied as required.

The nature of the prizes provided may vary, and the form of the crane and grabber may be arranged to suit the prizes as is known. Although not described, a coin or token detectors or other means for receiving payment may be included.

1. A prize vending machine comprising:
a housing;
a crane mechanism with a grabber attached to one end thereof, the crane mechanism being controllable by a user to effect movement of the crane mechanism from a first position to a user-influenced second position at which position a first grab attempt to grab a prize from within the housing is made; and
a repeat grab control operable by the user, wherein the repeat grab control is enabled after movement of the grabber from the first position to the second position and actuation of the repeat grab control when enabled causes the crane mechanism to repeat the first grab attempt whilst the crane mechanism remains in the second position.

2. A prize vending machine as claimed in claim 1 wherein the repeat grab function is disabled when a prize is detected in the grabber.

3. A prize vending machine as claimed in claim 2 further comprising an infrared sensor or a switch in the grabber to detect a prize in the grabber.

4. A method of operation of a prize vending machine having a crane mechanism and grabber, the method comprising:
effecting movement of the crane mechanism under user control from a first position to a user-influenced second position;
carrying out a grab attempt at the second position;
enabling actuation of a repeat grab control; and
if the repeat grab control is actuated, repeating the grab attempt at the second position, and otherwise returning the crane mechanism to the first position.

5. A method according to claim 4 including testing whether a prize has been picked up in the grabber, and enabling actuation of the repeat grab control if no prize is detected but not otherwise.
